(19) United States
(12) Patent Application Publication
(10) Pub. No.: US 2013/0205066 A1
(43) Pub. Date: Aug. 8, 2013

(54) ENHANCED WRITE ABORT MANAGEMENT IN FLASH MEMORY

(71) Applicants: Gautam A. Dusija, San Jose, CA (US); Jianmin Huang, Sunnyvale, CA (US); Chris Avila, Saratoga, CA (US)

(72) Inventors: Gautam A. Dusija, San Jose, CA (US); Jianmin Huang, Sunnyvale, CA (US); Chris Avila, Saratoga, CA (US)

(73) Assignee: SANDISK TECHNOLOGIES INC., Plano, TX (US)

(21) Appl. No.: 13/365,595

(22) Filed: Feb. 3, 2012

(51) Int. Cl. G06F 12/00

(52) U.S. Cl. 711/103

(57) ABSTRACT

A memory system or flash card may include safe zone blocks where data is written in case of an error condition, such as a write abort. The system may utilize predetermined risk zones when selecting the data that is written to the safe zone blocks. For example, data written to a lower page may be one example of data that is a predetermined risk. Upon receiving a write command, the data that is written to a lower page may be written to a safe zone either in parallel or after the write operation.

### TECHNICAL FIELD

This application relates generally to memory devices. More specifically, this application relates to protecting data against a write abort in non-volatile semiconductor flash memory.

### BACKGROUND

Non-volatile memory systems, such as flash memory, have been widely adopted for use in consumer products. Flash memory may be found in different forms, for example in the form of a portable memory card that can be carried between host devices or as a solid state disk (SSD) embedded in a host device. During normal host operation, a write abort or erase abort may occur and there is a risk of losing data that was programmed in a previous host command.

For example, binary and Multi-Level Cell (MLC) NAND Flash Memory are forms of non-volatile memory (NVM) that are capable of high data storage densities and high performance, however, a power failure due to hot removal, brownout, blackout or the like may cause data corruption or loss due to the nature of the way in which data is written to this type of memory. Typically a “page” or group of bits at a time is written to the NVM. If a power failure occurs during a write cycle/program operation, something less than all of the bits of the page may be programmed successfully in the NVM. When the page containing unsuccessfully programmed bits is read back, some bits may have the new value, some will have the old value and, as a result, the page may be corrupted.

### SUMMARY

It may be desirable to identify any memory portion that may be partially programmed or partially erased so that steps can be taken to recover the data, and to avoid programming further data in a manner that might cause it to also be corrupted by storing it in partially programmed or partially erased cells. In order to address this problem, a card or memory system may include safe zone blocks where data is written so that it can be recovered in case of a write abort. If a write abort occurs, the data written into the safe zone block may be protected. If there are predetermined risk zones within the memory that are written to, then the data may be written to the safe zone in parallel or after writing the data to the predetermined risk zones. Data written to a lower page may be one example of data that is a predetermined risk, so that data may also be written to the safe zone either in parallel or after the write operation.

According to a first aspect, a flash memory device includes a non-volatile storage having an array of memory blocks storing data. A controller in communication with the non-volatile storage is configured for receiving a write command for writing data to a memory block in the non-volatile storage. The controller also receives locations of predetermined risk zones in the memory block and writes the data to the memory block based on the write command. The controller identifies which of the written data is written to the predetermined risk zones and writes the identified data to a safe zone.

According to a second aspect, a method for memory writing in a non-volatile storage device having a controller and blocks of memory includes receiving a host write command and writing data to at least one of the blocks of memory in response to the host write command. A determination is made as to whether the data is written to a lower page in the at least one of the blocks of memory. The data that is determined to be written to a lower page is written to a safe zone block.

According to a third aspect, a flash memory device includes a non-volatile storage having an array of memory blocks storing data and a controller in communication with the non-volatile storage. The controller is configured for receiving a write command and writing data based on the received host write command. A determination is made as to whether the data is written to a lower page in a predetermined risk zone. The data that is determined to be written to a lower page in the predetermined risk zone is written to a safe zone block.

### BRIEF DESCRIPTION OF THE DRAWINGS

FIG. 1 is a block diagram of a host connected with a memory system having non-volatile memory.

FIG. 2 is a block diagram of an exemplary flash memory system controller for use in the system of FIG. 1.

FIG. 3 is an example physical memory organization of the system of FIG. 1.

FIG. 4 is an expanded view of a portion of the physical memory of FIG. 3.

FIG. 5 is a diagram illustrating charge levels in a multi-level cell (MLC) memory operated to store two bits of data in a memory cell.

FIG. 6 is a block diagram of an alternative memory communication system.

FIG. 7 is a flow chart illustrating writing with a safe zone block.

FIG. 8 is a flow chart illustrating an enhanced write abort process.

FIG. 9 is an illustration of exemplary memory blocks.

FIG. 10 is a timing diagram illustrating processing times.

### BRIEF DESCRIPTION OF THE PRESENTLY PREFERRED EMBODIMENTS

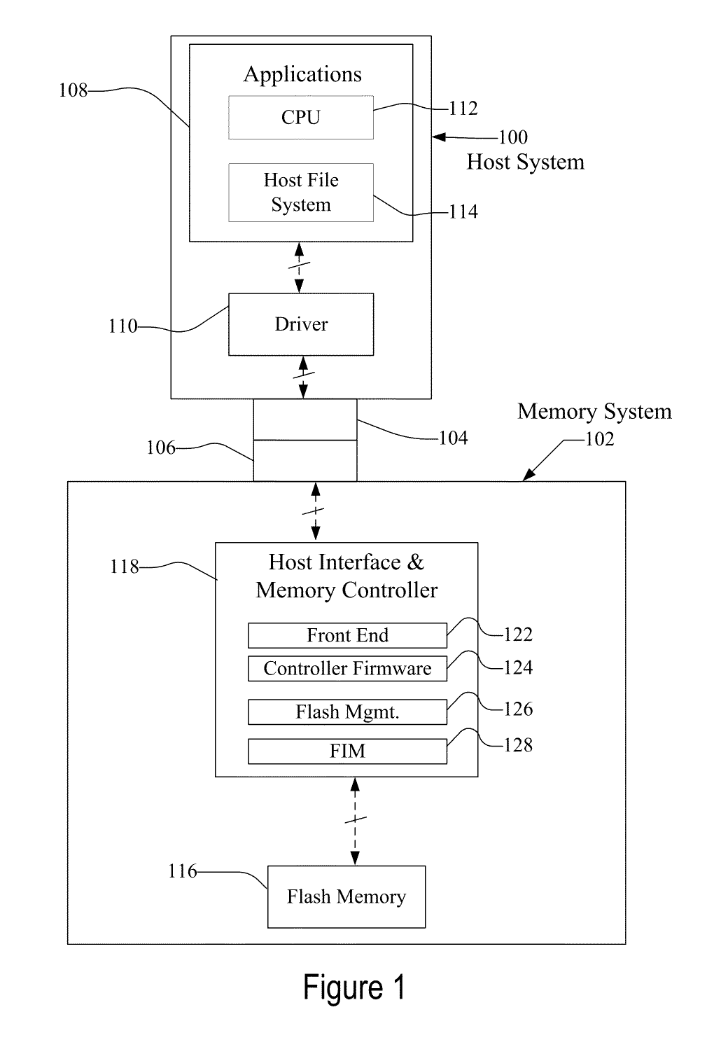

A flash memory system suitable for use in implementing aspects of the invention is shown in FIGS. 1-6. A host system 100 of FIG. 1 stores data into and retrieves data from a flash memory 102. The flash memory may be embedded within the host, such as in the form of a solid state disk (SSD) drive installed in a personal computer. Alternatively, the memory 102 may be in the form of a flash memory card that is removably connected to the host through mating parts 104 and 106 of a mechanical and electrical connector as illustrated in FIG. 1. A flash memory configured for use as an internal or embedded SSD drive may look similar to the schematic of FIG. 1, with one difference being the location of the memory system 102 internal to the host. SSD drives may be in the form of discrete modules that are drop-in replacements for rotating magnetic disk drives.

Examples of commercially available removable flash memory cards include the CompactFlash (CF), the MultiMediaCard (MMC), Secure Digital (SD), miniSD, Memory Stick, SmartMedia, TransFlash, and microSD cards. Although each of these cards may have a unique mechanical and/or electrical interface according to its standardized specifications, the flash memory system included in each may be similar. These cards are all available from SanDisk Corporation, assignee of the present application. SanDisk also provides a line of flash drives under its Cruzer trademark, which are hand held memory systems in small packages that have a Universal Serial Bus (USB) plug for connecting with a host by plugging into the host's USB receptacle. Each of these memory cards and flash drives includes controllers that interface with the host and control operation of the flash memory within them.

Host systems that may use SSDs, memory cards and flash drives are many and varied. They include personal computers (PCs), such as desktop or laptop and other portable computers, tablet computers, cellular telephones, smartphones, personal digital assistants (PDAs), digital still cameras, digital movie cameras, and portable media players. For portable memory card applications, a host may include a built-in receptacle for one or more types of memory cards or flash drives, or a host may require adapters into which a memory card is plugged. The memory system may include its own memory controller and drivers but there may also be some memory-only systems that are instead controlled by software executed by the host to which the memory is connected. In some memory systems containing the controller, especially those embedded within a host, the memory, controller and drivers are often formed on a single integrated circuit chip.

The host system 100 of FIG. 1 may be viewed as having two major parts, insofar as the memory 102 is concerned, made up of a combination of circuitry and software. They are an applications portion 108 and a driver portion 110 that interfaces with the memory 102. There may be a central processing unit (CPU) 112 implemented in circuitry and a host file system 114 implemented in hardware. In a PC, for example, the applications portion 108 may include a processor 112 running word processing, graphics, control or other popular application software. In a camera, cellular telephone or other host system 114 that is primarily dedicated to performing a single set of functions, the applications portion 108 includes the software that operates the camera to take and store pictures, the cellular telephone to make and receive calls, and the like.

The memory system 102 of FIG. 1 may include non-volatile memory, such as flash memory 116, and a system controller 118 that both interfaces with the host 100 to which the memory system 102 is connected for passing data back and forth and controls the memory 116. The system controller 118 may convert between logical addresses of data used by the host 100 and physical addresses of the flash memory 116 during data programming and reading. Functionally, the system controller 118 may include a front end 122 that interfaces with the host system, controller logic 124 for coordinating operation of the memory 116, flash management logic 126 for internal memory management operations such as garbage collection, and one or more flash interface modules (FIMs) 128 to provide a communication interface between the controller with the flash memory 116.

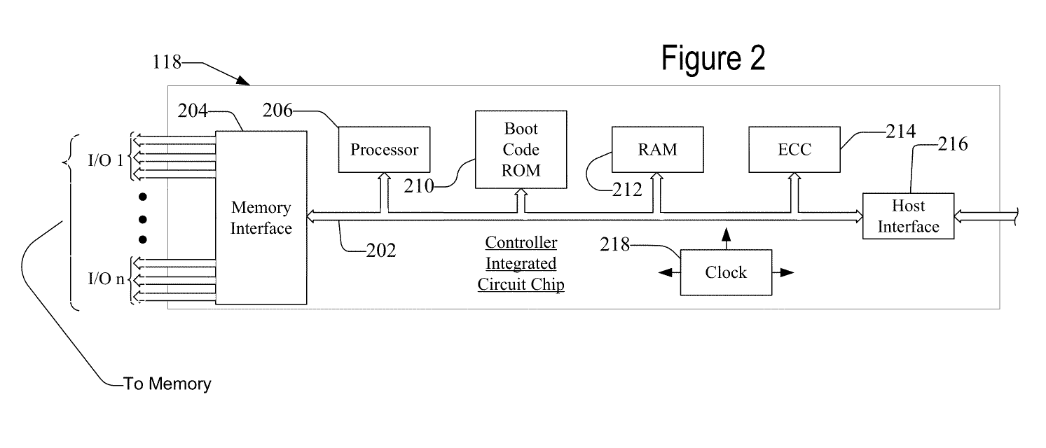

The system controller 118 may be implemented on a single integrated circuit chip, such as an application specific integrated circuit (ASIC) such as shown in FIG. 2. The processor 206 of the system controller 118 may be configured as a multi-thread processor capable of communicating via a memory interface 204 having I/O ports for each memory bank in the flash memory 116. The system controller 118 may include an internal clock 218. The processor 206 communicates with an error correction code (ECC) module 214, a RAM buffer 212, a host interface 216, and boot code ROM 210 via an internal data bus 202.

The ROM 210 may be used to initialize a memory system 102, such as a flash memory device. The memory system 102 that is initialized may be referred to as a card. The ROM 210 in FIG. 2 may be a region of read only memory whose purpose is to provide boot code to the RAM for processing a program, such as the initialization and booting of the memory system 102. The ROM may be present in the ASIC rather than the flash memory chip.

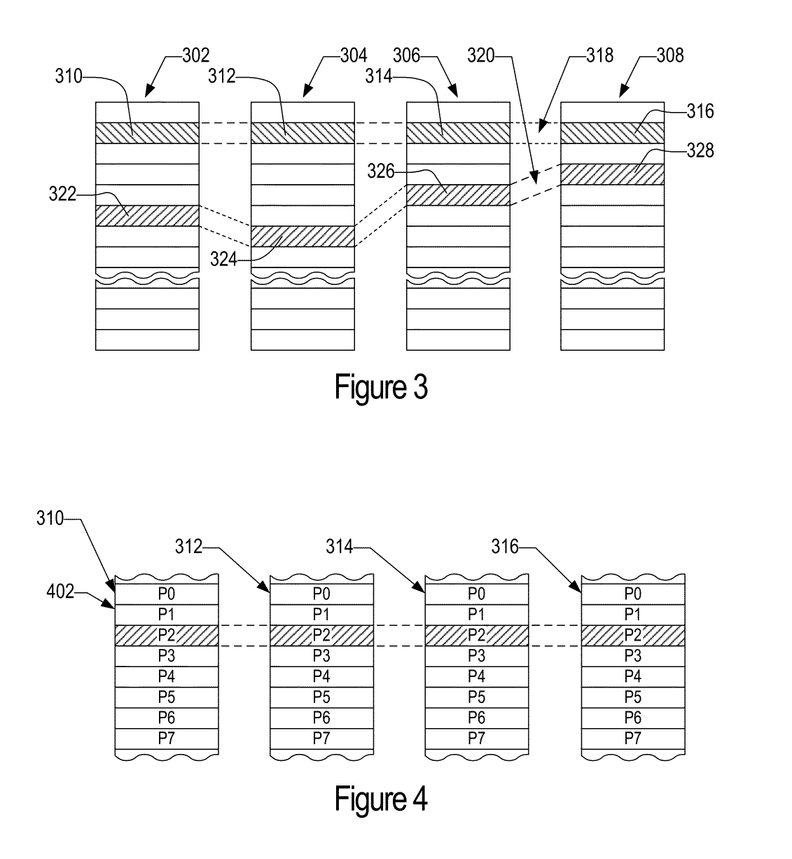

FIG. 3 conceptually illustrates an organization of the flash memory 116 (FIG. 1) as a cell array. Certain blocks or cell arrays may be safe zone blocks (SZB) for storing data that is written to predetermined risk zones as described below. The flash memory 116 may include multiple memory cell arrays which are each separately controlled by a single or multiple memory controllers 118. Four planes or sub-arrays 302, 304, 306, and 308 of memory cells may be on a single integrated memory cell chip, on two chips (two of the planes on each chip) or on four separate chips. The specific arrangement is not important to the discussion below. Of course, other numbers of planes, such as 1, 2, 8, 16 or more may exist in a system. The planes are individually divided into groups of memory cells that form the minimum unit of erase, hereinafter referred to as blocks. Blocks of memory cells are shown in FIG. 3 by rectangles, such as blocks 310, 312, 314, and 316, located in respective planes 402, 304, 306, and 308. There can be any number of blocks in each plane. Certain blocks may be reserved as safe zone blocks (SZBs) that are protected blocks for protecting data that is written to predetermined risk zones, such as a lower page.

As mentioned above, the block of memory cells is the unit of erase, the smallest number of memory cells that are physically erasable together. For increased parallelism, however, the blocks may be operated in larger metablock units. One block from each plane is logically linked together to form a metablock. The four blocks 310, 312, 314, and 316 are shown to form one metablock 318. In one embodiment, the SZB is one or more metablocks. All of the cells within a metablock are typically erased together. The blocks used to form a metablock need not be restricted to the same relative locations within their respective planes, as is shown in a second metablock 320 made up of blocks 322, 324, 326, and 328. Although it is usually preferable to extend the metablocks across all of the planes, for high system performance, the memory system can be operated with the ability to dynamically form metablocks of any or all of one, two or three blocks in different planes. This allows the size of the metablock to be more closely matched with the amount of data available for storage in one programming operation.

The individual blocks are in turn divided for operational purposes into pages of memory cells, as illustrated in FIG. 4. The memory cells of each of the blocks 310, 312, 314, and 316, for example, are each divided into eight pages P0-P7. Alternatively, there may be 16, 32 or more pages of memory cells within each block. The page is the unit of data programming and reading within a block, containing the minimum amount of data that are programmed or read at one time. However, in order to increase the memory system operational parallelism, such pages within two or more blocks may be logically linked into metapages. A metapage 402 is illustrated in FIG. 3, being formed of one physical page from each of the four blocks 310, 312, 314, and 316. The metapage 402, for example, includes the page P2 in each of the four blocks but the pages of a metapage need not necessarily have the same relative position within each of the blocks. A metapage may be the maximum unit of programming.

The memory cells may be operated to store two levels of charge so that a single bit of data is stored in each cell. This is typically referred to as a binary or single level cell (SLC) memory. Alternatively, the memory cells may be operated to store more than two detectable levels of charge in each charge storage element or region, thereby to store more than one bit of data in each. This latter configuration is referred to as multi level cell (MLC) memory. Both types of memory cells may be used in a memory, for example binary flash memory may be used for caching data and MLC memory may be used for longer term storage. The charge storage elements of the memory cells are most commonly conductive floating gates but may alternatively be non-conductive dielectric charge trapping material.

In implementations of MLC memory operated to store two bits of data in each memory cell, each memory cell is configured to store four levels of charge corresponding to values of “11,” “01,” “10,” and “00.” Each bit of the two bits of data may represent a page bit of a lower page or a page bit of an upper page, where the lower page and upper page span across a series of memory cells sharing a common word line. Typically, the less significant bit of the two bits of data represents a page bit of a lower page and the more significant bit of the two bits of data represents a page bit of an upper page.

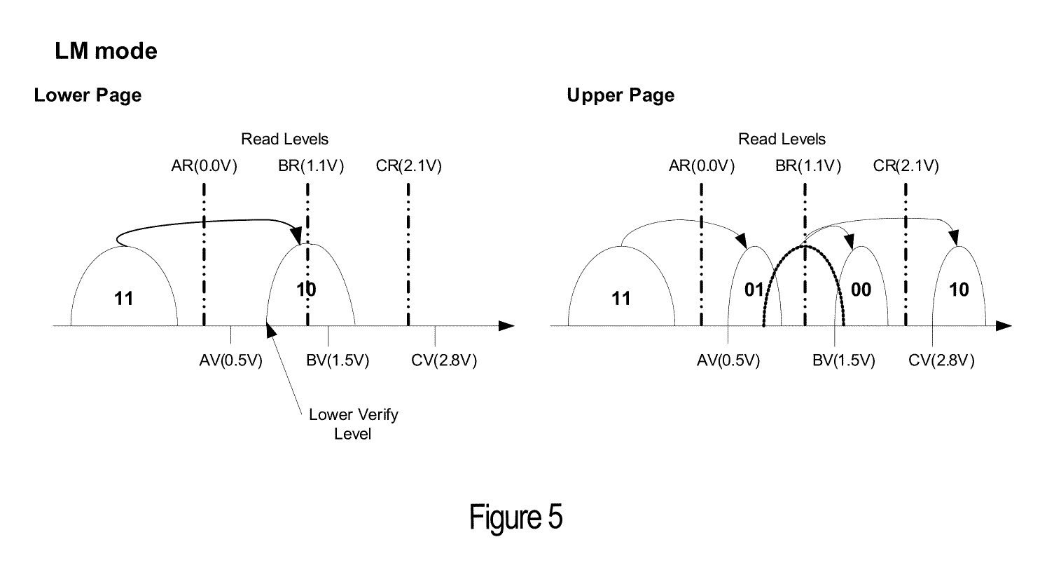

FIG. 5 illustrates one implementation of the four charge levels used to represent two bits of data in a memory cell. A value of “11” corresponds to an un-programmed state of the memory cell. When programming pulses are applied to the memory cell to program a page bit of the lower page, the level of charge is increased to represent a value of “10” corresponding to a programmed state of the page bit of the lower page. The lower page may be considered a logical concept that represents a location on a multi-level cell (MLC). If the MLC is two bits per cell, a logical page may include all the least significant bits of the cells on the wordline that are grouped together. In other words, the lower page is the least significant bits.

For a page bit of an upper page, when the page bit of the lower page is programmed (a value of “10”), programming pulses are applied to the memory cell for the page bit of the upper page to increase the level of charge to correspond to a value of “00” or “10” depending on the desired value of the page bit of the upper page. However, if the page bit of the lower page is not programmed such that the memory cell is in an un-programmed state (a value of “11”), applying programming pulses to the memory cell to program the page bit of the upper page increases the level of charge to represent a value of “01” corresponding to a programmed state of the page bit of the upper page.

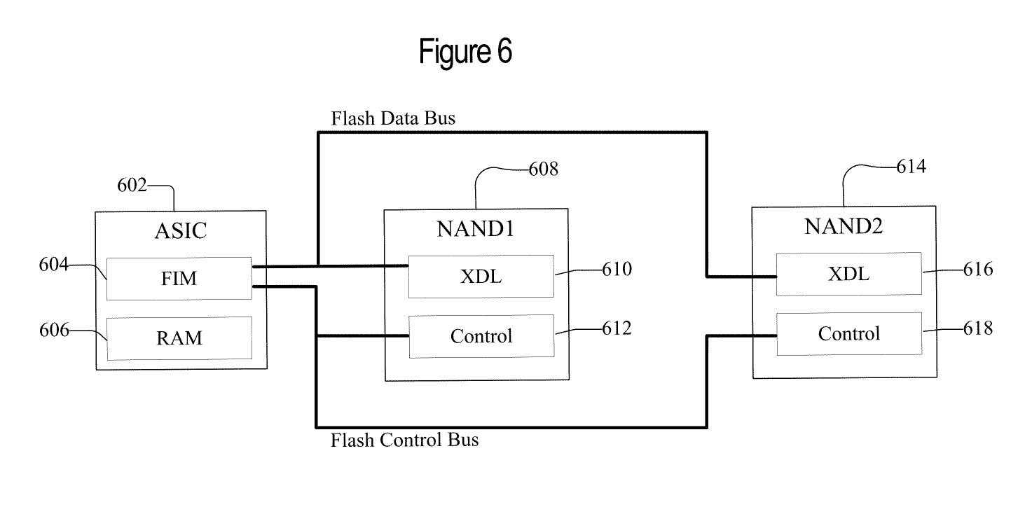

FIG. 6 is a block diagram of an alternative memory communication system. An application-specific integrated circuit (ASIC) 602 may include a flash interface module (FIM) 604 and random access memory (RAM) 606. The ASIC 602 may be a chip that communicates with multiple flash memory modules or devices, such as NANDs 608, 614. The FIM 604 communicates data over the flash data bus and communicates control commands over the flash control bus. The NAND1 608 and NAND2 614 are types of flash memory that receive commands and data from the FIM 604 of the ASIC 602. Each of the NAND1 608 and NAND2 614 include controls 612, 618, respectively, for receiving control signals from the ASIC 602. Likewise, each of the NAND1 608 and NAND2 614 include an eXternal Data Latch (XDL) 610, 616, respectively, for receiving data signals from the ASIC 602. Although the flash data bus and flash control bus are illustrated as separate busses that communicate with the XDL 610, 616 and Control 612, 618 of the respective NANDs 608, 614, there may be a singular bus for communication.

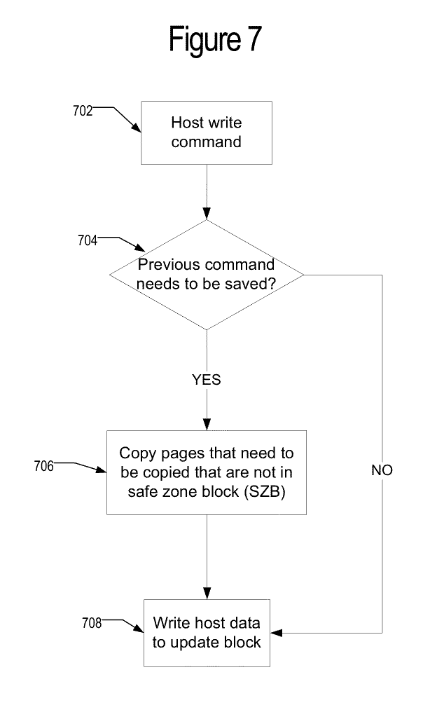

FIG. 7 is a flow chart illustrating writing with a safe zone block. In block 702, a host write command is received. In block 704, a determination is made as to whether the previous command needs to be saved. For example, if the previous command is being written to a predetermined risk zone, then the pages may be copied into the safe zone block (SZB) in block 706. If the previous command in block 704 does not need to be saved, then the host data is written to the update block in block 708.

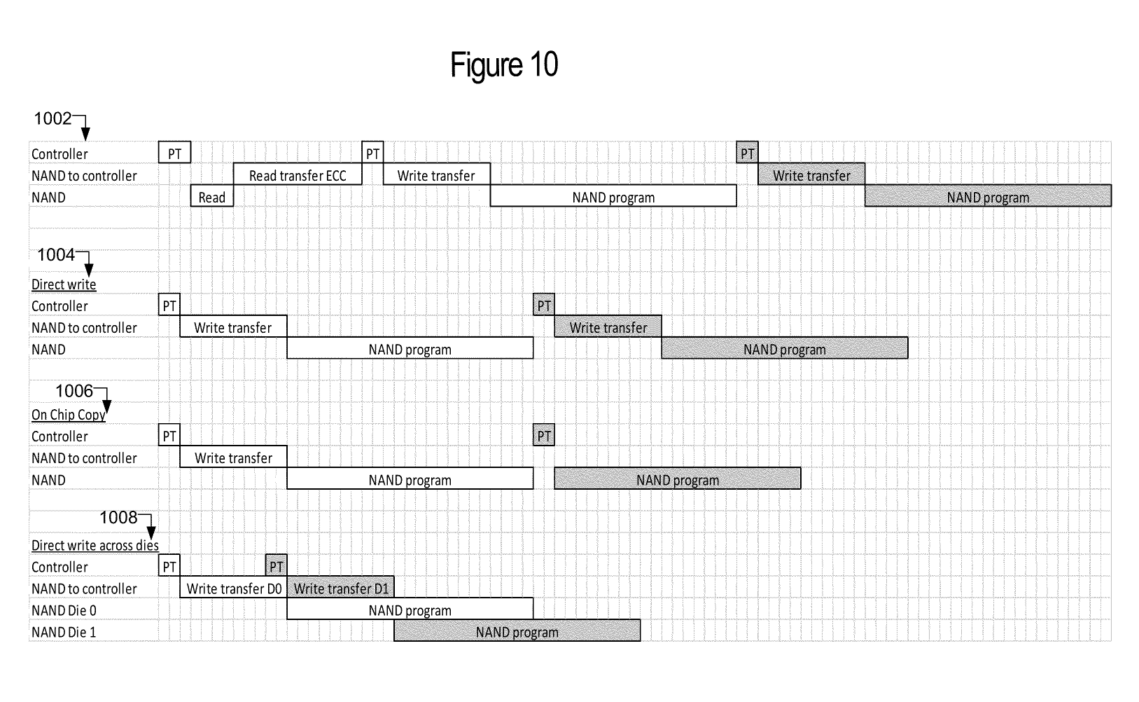

In order to maintain the validity of the data which was programmed in previous commands, each new write command may initiate a “Safe Mode” operation. All the data that can be corrupted in the case of a write abort is copied to a special block dedicated for this purpose and may be referred to as a safe zone block (SZB). The SZB may be used to preemptively address predetermined risk zones and protect data being written to those zones. In particular, data written to predetermined risk zones may be written to the SZB either in parallel with the host write or after the host write without triggering a copy operation. As described, copying the data to be written to the predetermined risk zone to the SZB may require some calculation on the identification of possible risk zones and a copy which may add to the overhead. Accordingly, writing that data to the SZB in parallel with the host write or after the host write without a copy operation may be more efficient and provide a processing savings. For example, FIG. 10 illustrates the timing of different embodiments for writing at-risk data to a SZB in different systems.

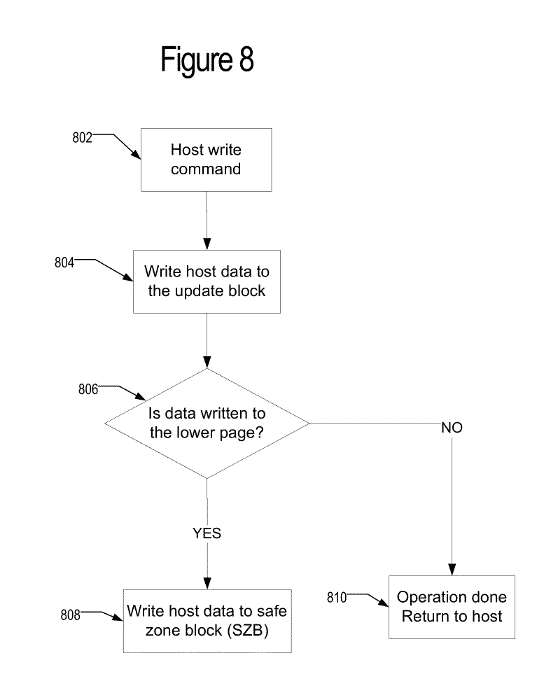

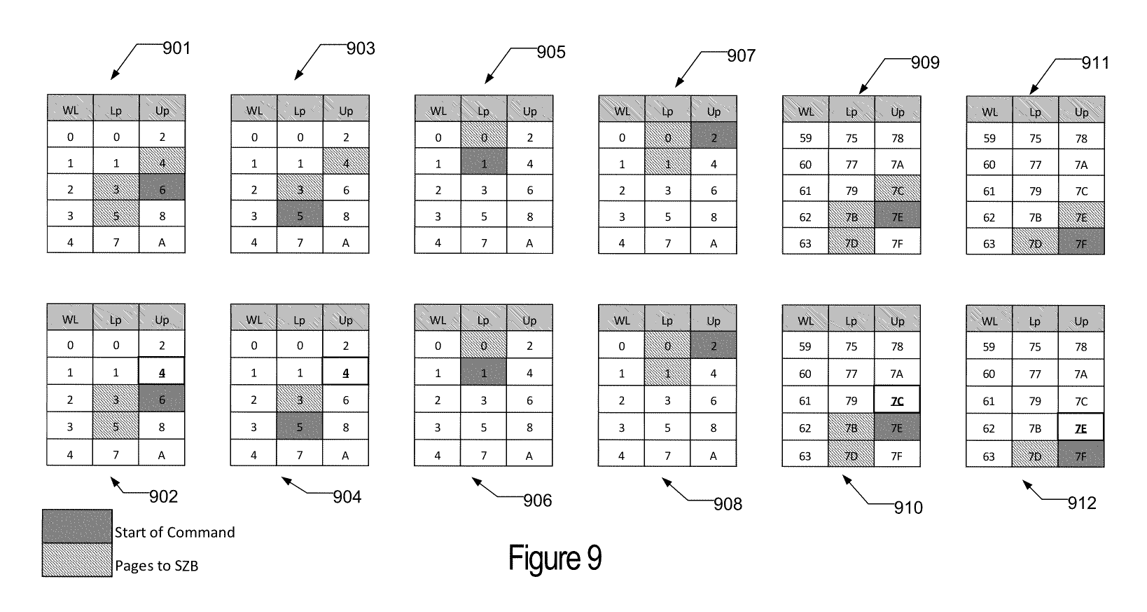

FIG. 8 is a flow chart illustrating an enhanced write abort process. A host write command is received in block 802. The host data is written to the update block in block 804. The update block may be the block or blocks in the memory at which the data from the write command is written. In block 806, a determination is made as to whether the data is written to the lower page. If the data is not determined to be written to a lower page, then the operation is done and is returned to the host in block 810. If the data is determined to be written to a lower page, then the host data is written to the safe zone block (SZB) in block 808. In other words, when data is to be written to a lower page, the lower page may be one example of a predetermined risk zone. FIG. 8 illustrates one embodiment for determining a risk zone in a flash memory which includes determining whether the data is written to a lower page. The lower page is described with respect to FIG. 5 and further described below with respect to FIG. 9. For MLC flash memory, the lower page may be just one example of a predetermined risk zone. In alternative embodiments, data from the lower and upper page of a previous wordline may be considered a predetermined risk zone and added to the safe zone.

FIG. 8 illustrates that the host data is initially written to the update block and then subsequently or even simultaneously, the data can be written to the SZB. FIG. 7 illustrated the use of a copy operation for utilizing the SZB which is eliminated in FIG. 8 and replaced with a write operation. In addition, the writing of the data to the update block and the SZB may be in parallel for a time savings and improved performance. However, even writing to the SZB after the host write may provide improved timing and performance. In block 808, the risk zone determination is predetermined based on whether the data is written to the lower page. In addition to being more efficient with less overhead, the parallel writing to the SZB in FIG. 8 may also provide additional protection from a write abort since the lower page is a predetermined potential risk zone.

FIG. 9 is an illustration of exemplary memory blocks. Each of the memory blocks 901-911 include a word line (WL), a lower page (Lp), and an upper page (Up). In other words, there is a two bit cell with a lower page and upper page value, which may be implemented as in FIG. 5. As illustrated in FIG. 9, there are five word lines for each of the blocks with data stored in the lower page and the upper page for each word line. One page in each of the blocks 901-911 is designated as the start of command. In other words, the start of command data is where the write starts. The diagonal lines illustrate those pages that are to be copied to the safe zone block (SZB). In other words, the pages to be copied to the SZB are risk zone pages that are identified in case of a write abort. If there is a write abort when writing one of the blocks, then the pages copied to the SZB may be recovered.

The second set of blocks 902, 904, 906, 908, 910, 912 correspond to the first set of blocks 901, 903, 905, 907, 909, 911 except only the lower page includes data to be written to the SZB. In other words, the Up value of 4 in block 901 is no longer copied to the SZB in block 902 because it is on the upper page. Likewise, the Up value of 4 in block 903 is no longer copied to the SZB in block 904 because it is on the upper page. Finally, the Up values of 7E and 7F in blocks 909, 911, respectively, are not copied to the SZB in blocks 910, 912, respectively, because they were on the upper page. In other words, the predetermined risk zones are only in the lower page for blocks 902, 904, 906, 908, 910, 912. Accordingly, FIG. 9 illustrates that the lower page data is written to the safe zone rather than both the upper page and lower page data.

When the write command is received, there is a determination of at risk data that may be at risk if the received write command fails. For example, a write abort that occurs upon receipt of the write command may result in the data stored in the risk zone to be corrupted. Accordingly, upon receipt of the write command, the at risk zones are identified and backed up to the SZB in case the write command results in an error, such as a write abort. This may be referred to as supplemental protection because the data that is protected (sent to the SZB) is what was written previously rather than the data that is to be written as a result of the write command. In particular, FIG. 7 illustrated the copying of pages prior to the writing of host data in response to a write command. In other words, the data that is copied to the SZB would be data from the previous write command rather than the current write command.

Referring back to FIG. 8, the host data written to the update block in block 804, and that data from the host data that is written to the lower page is written to the SZB in block 808. In other words, the backup operation (writing the SZB) occurs for the current data that is being written, while FIGS. 7 and 9 illustrate an alternative in which the data written to the SZB is from a previous write command rather than the current write command 802 as illustrated in FIG. 8. Accordingly, there is no copy operation of previously written data, rather the data is written in accordance with the write command and the risk zone data (data written to a lower page) is subsequently or concurrently written to the SZB.

FIG. 10 is a timing diagram illustrating processing times. In particular, the concurrent or subsequent writing of risk zone data to the SZB after writing to the update block upon receiving a write command may be faster and more efficient than a copy operation that copies risk zone data to the SZB. Process 1002 is when data is written and data is copied to the SZB before the host data write. In particular, the shaded processing time (PT), shaded write transfer, and shaded NAND program at the end of the timing diagram illustrate actual host data write operations. The non-shaded portions in FIG. 10 illustrate safe zone operations. Process 1004 is an illustration of a direct write. The process 1004 eliminates the Read and Read transfer error correction code (ECC). Also, the processing time (PT) in process 1004 is shortened from process 1002. Process 1002 has two boxes for processing time, which is reduced to one box in process 1004. The order of safe zone writing or host data writing may be switched for processes 1004, 1006, and 1008.

The on-chip copy (OCC) process 1006 is further shortened by eliminating the write transfer to the SZB from process 1004. OCC may be utilized when the SZB is on the same die as the host data that will be written. In a write operation the data may be written to the SZB. On completion of this operation the data loaded to the NAND XDL for the SZB operation may not be cleared and thus the same data may be used to program the same data in the update block. Clearing the XDL may be a command sequence option in the NAND.

In process 1008, if the SZB is on a different die than the block die that you are writing to, then the writing for the NAND program can take place simultaneously on the different die to further decrease the timing. Two dies in the NAND may operate in parallel. The commands and data may be sent to a particular die and its programming may be started. Once the programming for that die has started, the bus may be free for accessing the other die. If the host data update block and the SZB are on two dies then the SZB can be written to first and when the bus frees up the host data can be written by sending the commands and data to the other die.

As discussed, the writing of data to the update block and/or the SZB may be accomplished by the controller on the card. The risk zones may be predetermined and may be stored on the card for access by the controller. Likewise, the algorithm for predetermining the risk zones may be stored on the card and/or may be stored as part of the firmware code, which may be stored on the NAND and is read into the controller code RAM region for each boot. In one embodiment, the locations of the risk zones that are predetermined and/or the algorithm for making that determination is stored on ROM. In one example, the risk zones are predetermined as described in U.S. Pat. No. 6,988,175, which is herein incorporated by reference.

The writing to the memory block based on the write command may be an internal operation and no data is sent from a host. A host write command may trigger an internal copy operation or garbage collection. On such an internal operation this protection may also apply, so it is not only present on host data writes.

The safe zone block (SZB) stores data that may be used in case of an error condition. The SZB data may become obsolete over time. In one embodiment, the data stored in the SZB is at risk for the immediately preceding write operation. After two or three writes to the safe zone, the data written earlier may become obsolete. The list of entries in the safe zone may be a rolling list or queue. Once the block is full, the valid data may be moved to another block, and the original full block may be erased, with the new block becoming the safe zone block. The erased block is free to be used by the system.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A flash memory device comprising:
a non-volatile storage having an array of memory blocks storing data; and
a controller in communication with the non-volatile storage, the controller is configured for:
receiving a write command for writing data to a memory block in the non-volatile storage;
writing the data to the memory block based on the write command;
identifying which of the written data is written to predetermined risk zones, wherein the identification further comprises identifying which of the written data is written to a lower page; and
writing the identified data to a safe zone.

2. The device of claim 1 wherein the identifying is a simultaneous determination of when the data will be written to one of the predetermined risk zones and to a lower page.

3. The device of claim 2 wherein the writing further comprises:
writing the data that is written to the lower page into the safe zone.

4. The device of claim 1 wherein the writing the identified data to the safe zone is subsequent to the writing the data to the memory block based on the write command.

5. The device of claim 4 wherein the writing to the memory block based on the write command comprises an internal operation and no data is sent from a host.

6. The device of claim 1 wherein the writing the identified data to the safe zone is concurrent with the writing the data to the memory block based on the write command.

7. The device of claim 1 wherein the safe zone is one or more of the memory blocks that act as a backup for data that is written to the risk zones.

8. The device of claim 1 wherein the risk zones are memory cells that may be corrupted if the write command results in a write abort.

9. A method for memory writing comprising:
in a non-volatile storage device having a controller and blocks of memory, the controller:
receives a host write command;
writes data to at least one of the blocks of memory in response to the host write command;
determines whether the data is written to a lower page in the at least one of the blocks of memory; and
writes the data that is determined to be written to a lower page to a safe zone block.

10. The method of claim 9 wherein the writing of the data to the safe zone block is performed in parallel with the writing of the data in response to the host write command.

11. The method of claim 9 wherein the writing of the data to the safe zone block is performed subsequent to the writing of the data in response to the host write command.

12. The method of claim 11 wherein the writing of the data in response to the host write command comprises an internal operation and no data is sent from the host.

13. The method of claim 9 wherein the safe zone block is one or more of the memory blocks that act as a backup for data that is written to the lower pages.

14. The method of claim 9 wherein the data that is written to the safe zone block is data that may be corrupted if the host write command results in a write abort.

15. The method of claim 9 wherein the controller:
predetermines risk zones in the memory blocks; and
identifies which of the written data is written to the predetermined risk zones;
wherein the controller determines whether the data is written to a lower page by determining whether the data is written to a lower page in one of the predetermined risk zones.

16. The method of claim 15 wherein the data that the controller writes to the safe zone block is the data is written to a lower page in one of the predetermined risk zones.

17. A flash memory device comprising:
a non-volatile storage having an array of memory blocks storing data; and
a controller in communication with the non-volatile storage, wherein the controller is configured for:
receiving a write command;
writing data based on the received host write command;
determining whether the data is written to a lower page in a predetermined risk zone; and
writing the data that is determined to be written to a lower page in the predetermined risk zone to a safe zone block.

18. The device of claim 17 wherein writing the determined data to the safe zone is subsequent to the writing the data based on the received host write command.

19. The device of claim 17 wherein writing the determined data to the safe zone is concurrent with the writing the data based on the received host write command.

20. The device of claim 17 wherein the safe zone block is one or more of the memory blocks that act as a backup for data that is written to a lower page in the predetermined risk zones.

21. The device of claim 17 wherein the writing the data comprises an internal operation wherein no data is sent to the memory blocks from a host.
